(19) United States
(12) Patent Application Publication
(10) Pub. No.: US 2004/0177910 A1
(43) Pub. Date: Sep. 16, 2004

(54) Bicycle wheel with inner and outer tire members

(76) Inventor: Chao-Ying Chen, Tainan Hsien (TW)

Correspondence Address: WHYTE HIRSCHBOECK DUDEK S C, 555 EAST WELLS STREET, SUITE 1900, MILWAUKEE, WI, 53202, US

(21) Appl. No.: 10/386,039

(22) Filed: Mar. 11, 2003

(51) Int. Cl. B60C 15/06

(52) U.S. Cl. 152/381.6

(57) ABSTRACT

A bicycle wheel includes an annular wheel rim and inner and outer tire members. The wheel rim has two outer side walls spaced apart from each other, two inner side walls disposed between the outer side walls, and a base wall interconnecting radial inner ends of the outer and inner side walls. The outer tire member has two opposite longitudinal edges engaging radial outer ends of the outer side walls, respectively, and cooperates with the wheel rim to confine a first inflation chamber. The inner tire member is disposed within the first inflation chamber between the inner side walls of the wheel rim, and is mounted on the base wall. The inner tire member confines a second inflation chamber and abuts against the inner side walls when inflated.

### BACKGROUND OF THE INVENTION

1. Field of the Invention

The present invention relates to a bicycle wheel, more particularly to a bicycle wheel with inner and outer tire members.

2. Description of the Related Art

A bicycle wheel generally includes an annular wheel rim, a hub disposed within the wheel rim, a plurality of radially extending spokes for mounting the wheel rim on the hub, and a tire unit mounted on the wheel rim. The wheel rim typically includes spaced-apart annular lateral side walls and an annular base wall interconnecting radial inner edges of the lateral side walls. In a first type of a conventional bicycle wheel, the tire unit includes an outer tire member and an inflatable inner tire member disposed inside the outer tire member. The outer tire member has two opposite longitudinal edges hooked at radial outer edges of the lateral side walls of the wheel rim, and is bloated when the inner tire member is inflated. Since the inner tire member is usually disposed close to an inner surface of the outer tire member after inflation, when the outer tire member is accidentally pierced, it is possible that the inner tire member would be pierced at the same time. This results in quick air leakage via a plurality of spoke mounting holes formed in the base wall. To solve the aforementioned problem, a second type of a conventional bicycle wheel has been proposed heretofore. In the second type of the conventional bicycle wheel, an inner tire member is not provided. The wheel rim is further formed with a bridging wall disposed around the base wall and extending between the lateral side walls. The bridging wall cooperates with the lateral side walls and the outer tire member to confine an inflation chamber. When the outer tire member is accidentally pierced, rapid escape of air from the inflation chamber can be suppressed. Accordingly, the bicycle wheel still works for a period of time. However, in certain circumstances, such as during a bicycling race, the outer tire member could be twisted such that the longitudinal edges thereof would be removed and disengaged from the radial outer edges of the lateral side walls of the wheel rim. This will result in quick air leakage and expose the bicycle rider to danger.

### SUMMARY OF THE INVENTION

Therefore, the object of the present invention is to provide a bicycle wheel which includes inner and outer tire members and which still works when the outer tire member is accidentally damaged.

Accordingly, the bicycle wheel of the present invention includes an annular wheel rim with a central axis, an annular outer tire member, and an annular inner tire member. The wheel rim includes a pair of annular outer side walls spaced apart from each other in a first direction parallel to the central axis, and a pair of annular inner side walls which are disposed between the outer side walls and which are spaced apart from each other in the first direction. Each of the outer and inner side walls has a radial inner end proximate to the central axis and a radial outer end distal to the central axis. The wheel rim further includes an annular base wall which extends between the outer side walls and which interconnects the radial inner ends of the outer and inner side walls. The outer tire member has an annular tire wall with two opposite longitudinal edges which engage the radial outer ends of the outer side walls of the wheel rim, respectively. The annular tire wall cooperates with the wheel rim to confine a first inflation chamber. The inner tire member is disposed within the first inflation chamber between the inner side walls of the wheel rim, and is mounted on the base wall. The inner tire member confines a second inflation chamber, and abuts against the inner side walls when inflated.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary sectional view of a first preferred embodiment of the bicycle wheel of the present invention;

FIG. 2 is an enlarged fragmentary sectional view of the first preferred embodiment, showing a state when an outer tire member is damaged; and

FIG. 3 is an enlarged fragmentary sectional view of a second preferred embodiment of the bicycle wheel of the present invention.

### DETAILED DESCRIPTION OF THE PREFERRED EMBODIMENTS

Before the present invention is described in greater detail, it should be noted that like elements are denoted by the same reference numerals throughout the disclosure.

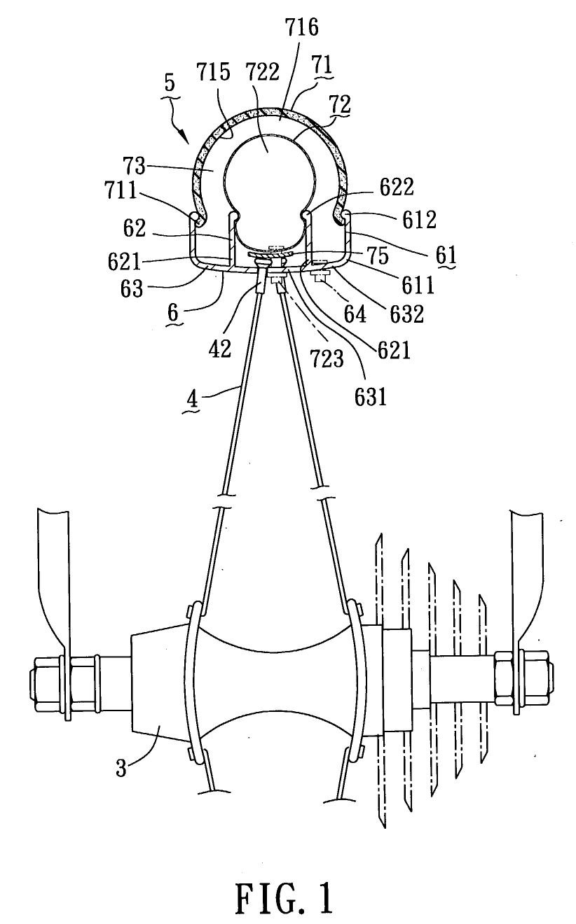

Referring to FIG. 1, the first preferred embodiment of the bicycle wheel 5 according to the present invention is shown to be installed on a bicycle hub 3, and includes an annular wheel rim 6 having a central axis coaxial with the bicycle hub 3, and annular inner and outer tire members 72, 71. A plurality of radially extending spokes 4 are arranged around the hub 3 for mounting the wheel rim 6 on the hub 3. Each of the spokes 4 is fastened to the wheel rim 6 with the use of a respective spoke fastener 42.

The wheel rim 6 is an integrally formed annular rim body with a central axis, and includes a pair of annular outer side walls 61, a pair of annular inner side walls 62, and an annular base wall 63. The outer side walls 61 are spaced apart from each other in a first direction of the wheel rim 6 parallel to the central axis. The inner side walls 62 are disposed between the outer side walls 61, and are spaced apart from each other in the first direction. Each of the outer and inner side walls 61, 62 extends radially, and has a radial inner end 611, 621 proximate to the central axis, and a hooked radial outer end 612, 622 distal to the central axis. The base wall 63 extends transversely between the outer sidewalls 61, and interconnects the radial inner ends 611, 621 of the outer and inner side walls 61, 62. The base wall 63 has a middle section 631 extending between the radial inner ends 621 of the inner side walls 62, and a pair of lateral sections 632, each of which extends between the radial inner end 611 of one of the outer side walls 61 and the radial inner end 621 of an adjacent one of the inner side walls 62. The middle section 631 is formed with a plurality of spoke mounting holes 633 for mounting the spoke fasteners 42. The spoke fasteners 42 have head portions abutting against a radial outer side surface of the base wall 63. An annular liner 75 is provided between the head portions of the spoke fasteners 42 and the inner tire member 72.

The outer tire member 71 has an annular tire wall with a generally U-shaped cross-section which opens in a radial inward direction, and two opposite longitudinal edges 711 engaging the radial outer ends 612 of the outer side walls 61 of the wheel rim 6, respectively. The outer tire member 71 cooperates with the wheel rim 6 to confine a first inflation chamber 73, and has a concave inner side surface 715 confronting the first inflation chamber 73. A first valve unit 64 is mounted on one of the lateral sections 632 of the base wall 63, and extends through the base wall 63 and into the first inflation chamber 73 to permit inflation of the first inflation chamber 73.

The inner tire member 72 is disposed within the first inflation chamber 73, and confines a second inflation chamber 722 therein. The inner tire member 72 is disposed between the inner side walls 62 proximate to the base wall 63. A second valve unit 723 is mounted on the middle section 631 of the base wall 63, and extends through the base wall 63, the liner 75 and into the second inflation chamber 722 to permit inflation of the inner tire member 72. The inner tire member 72 is thus mounted on the base wall 63 using the second valve unit 723.

After both the first and second inflation chambers 73, 722 are filled up with air, the inner tire member 72 abuts against the radial outer ends 622 of the inner side walls 62, and the outer tire member 71 bloats outwardly to form a clearance 716 between the inner side surface 715 of the outer tire member 71 and the inner tire member 72. In this state, air within the first inflation chamber 73 is unable to escape from between the inner side walls 62.

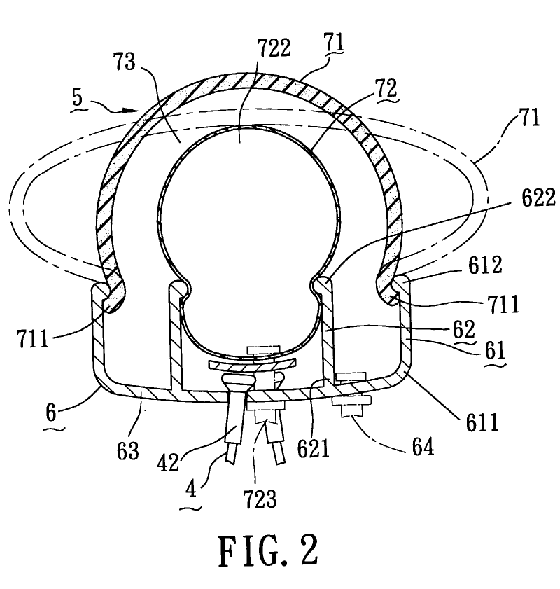

Referring to FIG. 2, when the outer tire member 71 is accidentally pierced or is twisted during advancing movement of the bicycle wheel 5 to result in air leakage from the first inflation chamber 73, only the outer tire member 73 will be deflated. The inner tire member 72 remains inflated to help support the bicycle wheel 5 so as to permit continuous advancing movement of the bicycle wheel 5. Immediate breakdown of a bicycle and possible danger to the bicycle rider can be prevented.

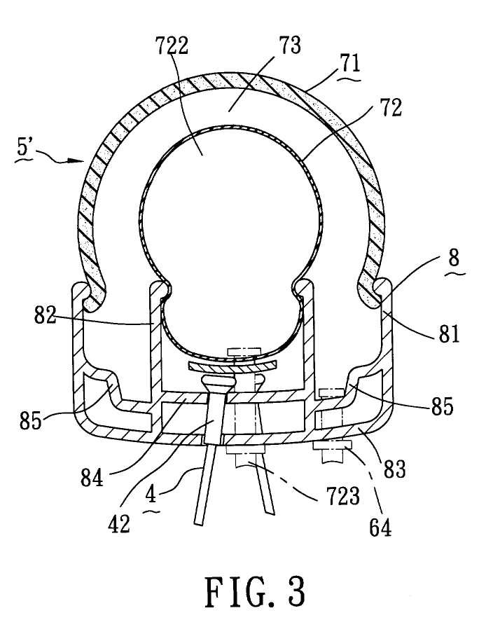

Referring to FIG. 3, the bicycle wheel 5′ of the second preferred embodiment of this invention is shown to have a structure similar to that of the previous embodiment, except that the wheel rim 8 is reinforced by providing a pair of annular first reinforcing walls 85, and an annular second reinforcing wall 84. Each of the first reinforcing walls 85 has a stepped configuration, and extends transversely between one of the outer side walls 81 and an adjacent one of the inner side walls 82. The first reinforcing walls 85 define peripheries of the first inflation chamber 73. The first valve unit 64 extends through one of the first reinforcing walls 85 into the first inflation chamber 73. The second reinforcing wall 84 extends transversely between the inner side walls 82 and is disposed between the inner tire member 72 and the base wall 83. The second valve unit 723 and the spoke fasteners 42 extend through the second reinforcing wall 84.

It has thus been shown that, with the provision of the first and second inflation chambers 73, 722, the bicycle wheel 5, 5′ of this invention is still operable when the outer tire member 71 is accidentally pierced, twisted, or otherwise damaged. Added safety can be provided to the bicycle rider accordingly.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A bicycle wheel comprising:
an annular wheel rim with a central axis, said wheel rim including a pair of annular outer side walls spaced apart from each other in a first direction parallel to the central axis, and a pair of annular inner side walls which are disposed between said outer side walls and which are spaced apart from each other in the first direction, each of said outer and inner side walls having a radial inner end proximate to said central axis and a radial outer end distal to said central axis, said wheel rim further including an annular base wall which extends between said outer side walls and which interconnects said radial inner ends of said outer and inner side walls;
an annular outer tire member having an annular tire wall with two opposite longitudinal edges which engage said radial outer ends of said outer side walls of said wheel rim, respectively, said annular tire wall cooperating with said wheel rim to confine a first inflation chamber; and
an annular inner tire member disposed within said first inflation chamber between said inner side walls of said wheel rim and mounted on said base wall, said inner tire member confining a second inflation chamber and a butting against said inner side walls when inflated.

2. The bicycle wheel as claimed in claim 1, wherein said outer tire member has an inner surface which forms a clearance with said inner tire member when said first inflation chamber is filled with air.

3. The bicycle wheel as claimed in claim 1, further comprising a first valve unit extending into said first inflation chamber to permit inflation of said outer tire member, and a second valve unit extending into said second inflation chamber to permit inflation of said inner tire member.

4. The bicycle wheel as claimed in claim 3, wherein said base wall of said wheel rim includes a middle section extending between said radial inner ends of said inner side walls, and a pair of lateral sections each of which extends between said radial inner end of one of said inner side walls and said radial inner end of an adjacent one of said outer side walls, said first valve unit being mounted on and extending through one of said lateral sections of said base wall, said second valve unit being mounted on and extending through said middle section of said base wall.

5. The bicycle wheel as claimed in claim 4, wherein said middle section of said base wall is formed with a plurality of spoke mounting holes that are arranged along length of said base wall, said bicycle wheel further comprising a plurality of spoke fasteners mounted in said spoke mounting holes, and an annular liner disposed between said spoke fasteners and said inner tire member, said second valve unit extending through said liner.

6. The bicycle wheel as claimed in claim 4, wherein said wheel rim further includes a pair of first reinforcing walls, each of which extends transversely between one of said outer side walls and an adjacent one of said inner side walls and defines a periphery of said first inflation chamber, said first valve unit extending through one of said first reinforcing walls.

7. The bicycle wheel as claimed in claim 4, wherein said wheel rim further includes a second reinforcing wall extending transversely between said inner side walls and disposed between said base wall and said inner tire member, said second valve unit extending through said second reinforcing wall.
